(19) United States
(12) Patent Application Publication
(10) Pub. No.: US 2010/0021007 A1
(43) Pub. Date: Jan. 28, 2010

(54) RECONSTRUCTION OF DATA PAGE FROM IMAGED DATA

(75) Inventors: Olaf Martinus Johannes Van 'T Erve, Geldrop (NL); Floris Crompvoets, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/441,475

(22) PCT Filed: Sep. 19, 2007
(86) PCT No.: PCT/IB2007/053783

§ 371 Date: Mar. 16, 2009

(30) Foreign Application Priority Data
Sep. 26, 2006 (EP) 06121251.0

(51) Int. Cl. G06K 9/00; G06K 9/76

(52) U.S. Cl. 382/103; 382/210

(57) ABSTRACT

The present invention relates to an electronic device (117) and a corresponding method for reconstructing a data page from an oversampled detected image of said data page. In order to avoid the necessity of using reference marks for said reconstructing it is provided an extraction unit (118) for extracting an oversampling factor from said oversampled detected image, a determination unit (119) for determining a correction information for a correction of said oversampled detected image with respect to said data page by using said extracted oversampling factor, and a correction unit (120) for correcting said oversampled detected image by using said determined correction information. The present invention relates particularly to an optical holographic device for reading out a data page recorded in a holographic recording medium (106).

### FIELD OF THE INVENTION

The present invention relates to an electronic device and a corresponding method for reconstructing a data page from an oversampled detected image of the data page. Further, the present invention relates to optical holographic device comprising said electronic device. Even further, the present invention relates to a corresponding method for use in said optical holographic device. Finally, the present invention relates to a computer program for implementing said methods in software.

### BACKGROUND OF THE INVENTION

Optical storage systems, in particular Holographic Data Storage Systems (HDSS), promise high data capacities (1 TByte on a 12-cm disc) and high data rates (Gbit/s). An advantage of holographic data storage systems over other optical storage systems is that they use the real 3D volume of the medium to store the data making high capacities possible. An overview of holographic data storage systems are given in “Holographic Data Storage Systems”, Lambertus Hesselink, Sergei S. Orlov, and Matthew C. Bashaw, Proceedings of the IEEE, vol. 92, no. 8, pp. 1231-1280, 2004.

In holographic data storage (HDS), digital data can be stored page based, i.e., as a data page, in a holographic medium. Laser light can be transmitted through a spatial light modulator (SLM), which contains the binary data. The interference pattern from this beam and a reference beam can be recorded in the medium as a recorded data page. The read-out of the recorded data page by an optical holographic device can be done using the reference beam only, and the original data page can be detected on a CCD sensor or a CMOS chip. Due to the holographic nature of the recording, hundreds of data pages can be stored at the same position in the holographic medium.

The image on the CCD sensor should be converted to the original binary data. One way of reconstructing a data page is by using a pixel matched SLM and CCD sensor. One possibility is that every pixel of the SLM is matched with one pixel on the CCD and only a threshold level is used to decide if a data bit is a zero or a one. However, this places a constraint on the alignment of all the optics of the optical holographic device.

Alternatively, a CCD with a higher resolution than the SLM can be used so that the data page is imaged inside the CCD area, i.e., the image is oversampled by the CCD so that an oversampled detected image is detected. Accordingly, in this kind of holographic data storage the magnification, rotation and the position of the data page image on the CCD are unknown. Alignment marks in the data page can now be used to calculate magnification, rotation and the position of the digital data on the CCD. These parameters are then used to reconstruct the digital data based on the position on the CCD.

To detect errors, in particular non-uniformities in the image detectors or in the profiles of he laser beams, some methods have been proposed, e.g. the method described in US 2005/0018263 uses a fractional delay filter technique in which coefficients for magnification and offset are determined based on registration marks in the detected image. Another method, described in WO 2005/057584 A1, proposes to detect a Moiré pattern in the detected imaged data page and to modify the imaged data page as a function of the Moiré pattern. Often, the reconstruction of a data page from a CCD image relies on the use of alignment marks.

### SUMMARY OF THE INVENTION

It is an object of the present invention to provide an improved electronic device and a corresponding method for reconstructing a data page from an oversampled detected image of the data page. Further, it is an object of the present invention to provide an optical holographic device and a corresponding method comprising said electronic device and method, respectively. Even further, a computer program for implementing said methods should be provided. In particular, it would be advantageous to achieve an electronic device and a corresponding method, which are not using reference marks or a Moiré pattern.

In a first aspect of the present invention it is provided an electronic device as defined in claim 1, said device comprising:

an extraction unit for extracting an oversampling factor from said oversampled detected image,

a determination unit for determining a correction information for a correction of said oversampled detected image with respect to said data page by using said extracted oversampling factor, and

a correction unit for correcting said oversampled detected image by using said determined correction information.

In a further aspect of the present invention it is presented an optical holographic device for reading out a data page recorded in a holographic recording medium, said device comprising:

an image detection unit for detecting an oversampled detected image of said recorded data page, and

an electronic device as defined in claim 1 for reconstructing a data page from said oversampled detected image.

In another aspect of the present invention it is presented a computer program comprising program code means for causing a computer to carry out the steps of the method as claimed in claims 11 or 12 when said computer program is carried out on a computer.

Corresponding methods are defined in further independent claims. Preferred embodiments of the invention are defined in the dependent claims. It shall be understood that the electronic device, the methods and the computer program have similar and/or identical preferred embodiments as defined in the dependent claims.

The present invention comprises as one basic idea the perception that it would be advantageous for reconstructing a data page from an oversampled detected image of said data page to extract correction information about the described non-uniformities from said oversampled detected image itself. This extracted correction information is then used for correcting said oversampled detected image, which finally avoids the necessity of using reference marks (also called alignment marks or fiducial markers) or a Moiré pattern for said reconstructing, contrary to most of the known methods.

In embodiments of the present invention, magnification, rotation and the position of the data can be extracted from the detected image without the use of alignment marks. A signal processing scheme provides resampling of the detected image with the correct oversampling factor and starting point (phase t0). Further, the oversampling factor can be extracted using for example a Fast Fourier Transform, FFT, or other known convolution transformation, and the starting point can be calculated using a modified convolution integral.

The two main advantages of not using alignment marks are the possibility of an avoidance of time consuming cross-correlation to accurately find the position of the alignment marks and the release of data space needed by the alignment marks thus leaving more space available for data while also providing robustness of the data retrieval process.

It is preferred that the extraction unit further comprises a deriving element for deriving a periodicity of dark lines in said oversampled detected image, wherein it is preferred that said deriving element further comprises a convolution transformation element for performing a convolution transformation, in particular a Fast Fourier Transform, FFT, over at least one column and/or row of said oversampled detected image to derive said periodicity.

In another preferred embodiment of the present invention said determination unit is further adapted for:

comparing said data of at least one column/row of said oversampled detected image with an artificial periodic function having a frequency which corresponds to said derived periodicity and having a known offset with respect to said data page,

repeating said comparison using at least one other known offset, and

determining among said compared known offsets a best match offset having a best match with an offset of data of at least one column/row of said oversampled detected image and determining said best match offset as a part of said correction information.

In another preferred embodiment of the present invention said determination unit is further adapted for

convoluting said artificial periodic function with at least one column/row of said oversampled detected image, and

detecting a maximum of said convolution.

According to another preferred embodiment of the present invention said determination unit may be further adapted for using a modified convolution integral which modification comprises multiplication of a data signal of said at least one column/row of said oversampled detected image and said periodic function and for shifting said periodic function by one period through said data signal.

In an embodiment of the present invention said correction unit can further comprise a resampling element for resampling on a line by line basis said oversampled detected image for its columns and/or rows by using said extracted oversampling factor and said determined offset. Preferably, a threshold element is provided for determining a threshold value for a slicer element by using a histogram per column and/or row and/or area of said oversampled detected image. Additionally, a starting element can be introduced for determining a beginning of said reconstructed data page by detecting at least one data edge of said data page by using a non-zero value of a sum of at least one column and/or row as said beginning of said reconstructed data page.

### BRIEF DESCRIPTION OF THE DRAWINGS

These and other aspects of the invention will be apparent from and elucidated with reference to the embodiment(s) described hereinafter. In the following drawings

FIG. 1 shows an embodiment of the inventive optical holographic device,

FIG. 2 shows a flow chart of an embodiment of the inventive method, and

FIG. 3 shows a flow chart illustrating the main steps of a corresponding computer program.

### DETAILED DESCRIPTION OF THE INVENTION

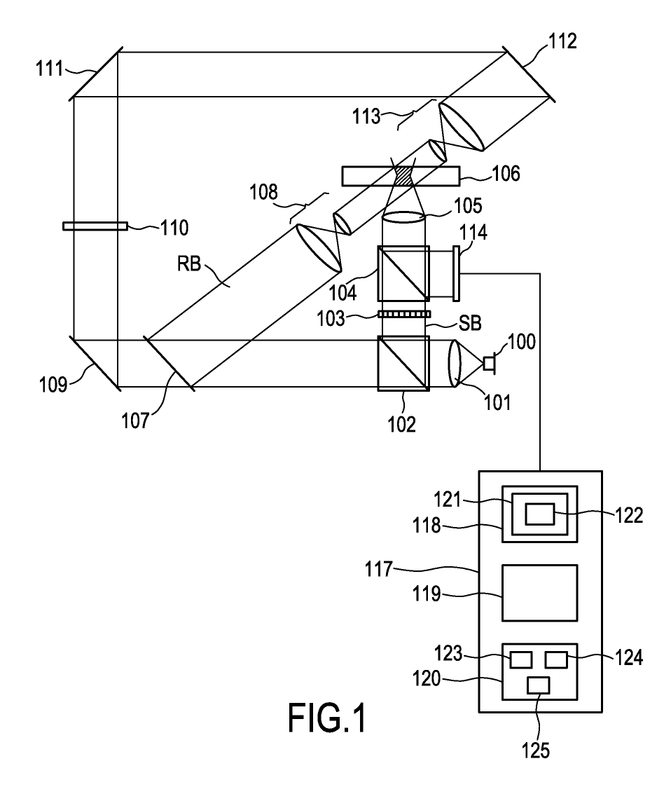

FIG. 1 shows an optical holographic device according to an embodiment of the present invention using phase conjugate read out. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113, a detector 114, an electronic device 117 comprising an extraction unit 118, a determination unit 119 and a correction unit 120. The optical device is intended to record in and read data from a holographic medium 106.

The electronic device 117 can be a dedicated integrated circuit or other hardware, that is separately distributed and that can, for instance, be added to existing holographic optical devices. Alternatively, the functions of the extraction unit 118, the determination unit 119 and the correction unit 120 can also be implemented in software running, e.g., on a computer or a microprocessor.

During recording of a data page in the holographic medium 106, half of the radiation beam generated by the radiation source 100 is sent towards the spatial light modulator 103 by means of the first beam splitter 102. This portion of the radiation beam is called the signal beam SB. Half of the radiation beam generated by the radiation source 100 is deflected towards the telescope 108 by means of the first deflector 107. This portion of the radiation beam is called the reference beam RB. The signal beam SB is spatially modulated by means of the spatial light modulator 103. The spatial light modulator 103 comprises transmissive areas and absorbent areas, which corresponds to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam RB is also focused on the holographic medium 106 by means of the first telescope 108. The data page is thus recorded in the holographic medium 106, in the form of an interference pattern as a result of interference between the signal beam SB and the reference beam RB. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam RB at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kinds of multiplexing, such as shift multiplexing, may also be used for recording data pages in the holographic medium 106.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that were used for recording this given hologram. The signal that is deflected by the second deflector 112 and focused in the holographic medium 106 by means of the second telescope 113 is thus the phase conjugate of the reference signal that were used for recording this given hologram. If for instance wavelength multiplexing has been used for recording the data pages in the holographic medium 106, and a given data page is to be read out, the same wavelength is used for reading this given data page.

The phase conjugate of the reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels. In the displayed embodiment the detector 114 has more pixels than the imaged data page, i.e. the image is oversampled by the detector 114. In any case, the imaged data page should be carefully aligned with the detector 114, in such a way that one bit or a given number of bits of the imaged data page impinges on the corresponding pixel of the detector 114.

Now, there are many degrees of freedom in the system, so that the imaged data page is not always carefully aligned with the detector 114. For example, a displacement of the holographic medium 106 with respect to the detector 114, in a direction perpendicular to the axis of the reconstructed signal beam, leads to a translational misalignment. A rotation of the holographic medium 106 or the detector 114 leads to an angular error between the imaged data page and the detector 114. A displacement of the holographic medium 106 with respect to the detector 114, in a direction parallel to the axis of the reconstructed signal beam, leads to a magnification error, which means that the size of a bit (or a give number of bits) of the imaged data page is different from the size of a pixel of the detector 114.

Further, as explained above, spatial light intensity fluctuations in the laser beams during writing of the data, as well as during read-out, lead to unwanted variations in the acquired image upon read-out. Still further, the non-uniform pixel response of the image detector 114 adds to these unwanted variations. In addition, the holographic medium 106 might scatter the laser light inhomogeneously, making the intensity fluctuations in the image even more severe. These variations make correct bit detection difficult.

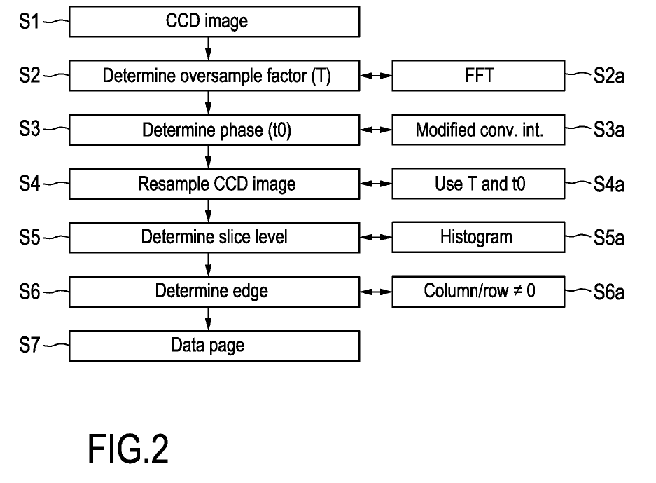

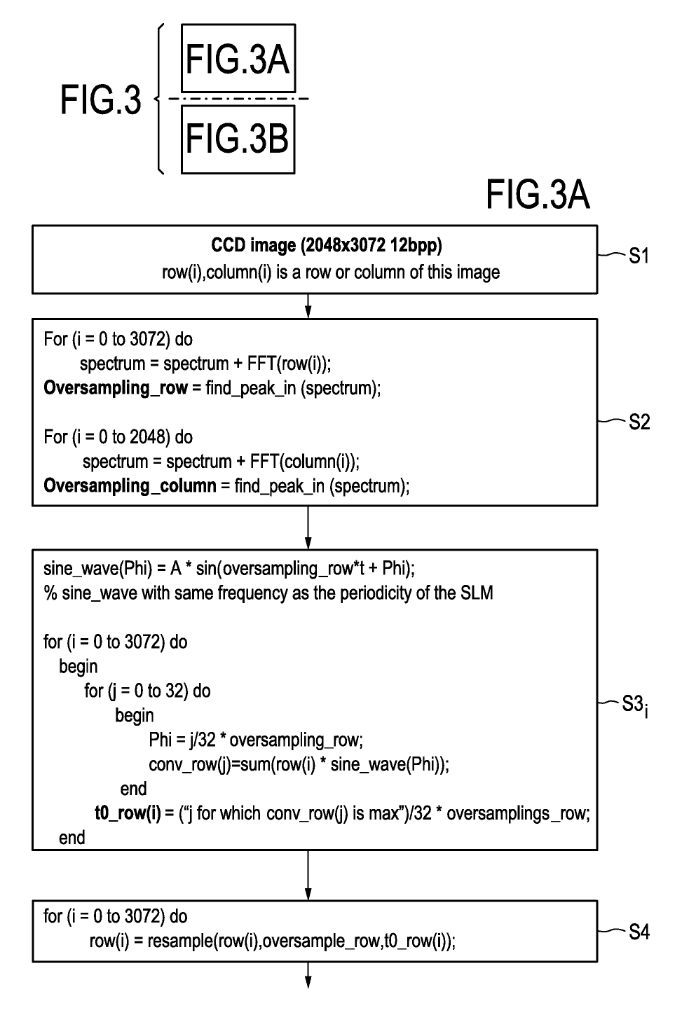

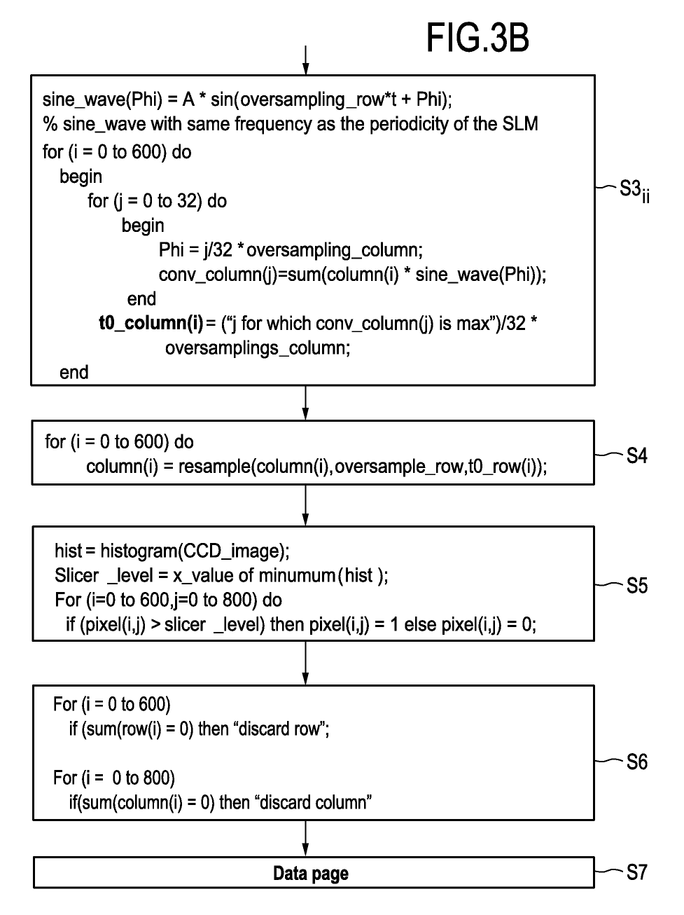

Hence, according to the present invention, the electronic device 117 for reconstructing a data page from an oversampled detected image of said data page uses the extraction unit 118 for extracting an oversampling factor from said oversampled detected image, the determination unit 119 for determining a correction information for a correction of said oversampled detected image with respect to said data page by using said extracted oversampling factor, and the correction unit 120 for correcting said oversampled detected image by using said determined correction information. The details of the function of the afore-mentioned units 118, 119 and 120 will be described below with respect to FIGS. 2 and 3.

FIG. 2 shows a flow chart of an embodiment of the inventive method for reconstructing a data page from an oversampled detected image of said data page. The flow chart will be described block-wise from top to bottom:

Block S1 “CCD image”: In HDS the binary data page is imaged by an SLM; for instance, an SLM is used with a resolution of 600×800 pixels. These pixels are imaged on a CCD with a resolution of 2048×3072 pixels.

Blocks S2 and S2a “Determine oversample factor (T)”: Since the pixels of the SLM are not continuous, dark lines between each pixel show up in the CCD image. The periodicity of these dark lines can be determined with for example a Fast Fourier Transform, FFT, or other known convolution transformation, over all lines or rows of the CCD image. The periodicity of these lines tells exactly how many CCD pixels correspond to one SLM pixel. A peak in a FFT of the CCD image of the data page shows the periodicity of the SLM pixels. For example, if the peak would be at 864, and 3072/864*2 is 3.55. Thus one SLM pixel would be imaged on 3.55 CCD pixels.

Blocks S3 and S3a “Determine phase (t0)”: To resample the CCD data a starting point should be provided. Now that the oversampling factor is known, it is possible to construct a periodic function, e.g. a sine wave, with the same frequency as the SLM pixels on the CCD. If the sine wave is convoluted with a column of the CCD, then the convolution of these two is at its maximum when the peaks of the sine wave are aligned with the peaks of the data signal. To calculate this a modified convolution integral can be used, which multiplies the data signal and the sine wave, but it only shifts the sine wave by one period through the data signal. In the following formula Φ is the oversampling factor and n is chosen to be 32 in this example.

$${\int }_{0}^{n} CCD ( column ) \times sin ( i \cdot \frac{Φ}{n} ) d i$$

In this example, this modified convolution is calculated for each column. Since the position of this maximum has a modulo of the oversampling factor, the difference in t0 between two neighboring columns is preferably not be more than half the oversampling factor, thus allowing for a rotation of maximum 45 degrees. For a badly aligned system the maximum rotation of the data page on the CCD can be more close to a few degrees, only. A linear extrapolation of t0 between every 30 columns would still allow a rotation of 5 degrees. The same procedure can be followed for the rows.

Blocks S4 and S4a “Resample CCD image”: The CCD data can now be resampled for both the columns and the rows, using the calculated oversampling factor and t0. The resampling in this example is done by linear extrapolation. More complex resampling methods such as “splines” might, however, be used as well.

Blocks S5 and S5a “Determine slice level”: Each sample now represents a bit. A histogram per line is used in this example to determine a threshold value for the slicer. The histogram could also have been chosen per area, depending on the intensity variations of the CCD image.

Blocks S6 and S6a “Determine edge”: A binary bit-synchronous data page is now available. All that is left is to find the beginning of the data, which can be done by detecting the data edges. A non-zero value of the sum of the column/row is a preferred telltale of the start of original page.

Block S7 “Reconstructed Data Page”: In the example of FIG. 2 the binary page was reconstructed as a whole. This method works equally well when the CCD image is divided in four or nine blocks. This can be useful to compensate for distortions of the imaging system.

One application of this invention is in the page based data retrieval of holographic data storage, since the exact position of the data page on the CCD image is unknown. It can also be used for any data storage and retrieval system where the exact alignment of the data on an array of sensors is unknown.

Another flow chart is depicted in FIG. 3. This flow chart uses for ease of understanding and comparability the order and the exemplary numbers of the embodiment of FIG. 2 as described above. On this basis the flow chart is showing the main program code blocks of a computer program according to a preferred embodiment of the present invention by which the above-described method can be implemented in software. To avoid a repeated description it is mainly referred to the description of FIG. 2 above, which is applicable to the following flow chart as well. Further to FIG. 2 the flow chart of FIG. 3 also shows another loop of blocks S3 and S4 for the columns. Accordingly, the flow of FIG. 3 is as follows:
Block S1: definitions
Block S2: Initialization of the steps “Extract oversampling factor for rows and columns”
Block S3i: “Determine phase (t0) for each row”, provide t0 row(3072)
Block S4: “Resample the CCD image for all rows”
Block S3ii: “Determine phase (t0) for each column”, provide t0_column(3072)
Block S4: “Resample the CCD image for all columns”, provide CCD image (600×800 12bpp)
Block S5: “Determine slicer level (e.g. global slicer)”, provide CCD image (600×800 1bpp)
Block S6: “Determine edge”
Block S7: reconstructed data page

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measured cannot be used to advantage.

The term “element” can be interpreted as indicating a solid part of a device, as indicating a step of a method and/or as indicating a part of a software program.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Electronic device (117) for reconstructing a data page from an oversampled detected image of said data page, said electronic device comprising:
an extraction unit (118) for extracting an oversampling factor from said oversampled detected image,
a determination unit (119) for determining a correction information for a correction of said oversampled detected image with respect to said data page by using said extracted oversampling factor, and
a correction unit (120) for correcting said oversampled detected image by using said determined correction information.

2. Electronic device as claimed in claim 1, wherein said extraction unit (118) further comprises:
a deriving element (121) for deriving a periodicity of dark lines in said oversampled detected image.

3. Electronic device as claimed in claim 2, wherein said deriving element (121) further comprises:
a convolution transformation element (122) for performing a convolution transformation, in particular a Fast Fourier Transform (FFT), over at least one column and/or row of said oversampled detected image to derive said periodicity.

4. Electronic device as claimed in claim 3, wherein said determination unit (119) is further adapted for:
comparing said data of at least one column/row of said oversampled detected image with an artificial periodic function having a frequency which corresponds to said derived periodicity and having a known offset with respect to said data page,
repeating said comparison using at least one other known offset, and
determining among said compared known offsets a best match offset having a best match with an offset of data of at least one column/row of said oversampled detected image and determining said best match offset as a part of said correction information.

5. Electronic device as claimed in claim 4, wherein said determination unit (119) is further adapted for:
convoluting said artificial periodic function with at least one column/row of said oversampled detected image, and
detecting a maximum of said convolution.

6. Electronic device as claimed in claim 5, wherein said determination unit (119) is further adapted for:
using a modified convolution integral which modification comprises multiplication of a data signal of said at least one column/row of said oversampled detected image and said periodic function, and
shifting said periodic function by one period through said data signal.

7. Electronic device as claimed in claim 1, wherein said correction unit (120) further comprises:
a resampling element (123) for resampling on a line by line basis said oversampled detected image for its columns and/or rows by using said extracted oversampling factor and said determined offset.

8. Electronic device as claimed in claim 1, wherein said correction unit (120) further comprises:
a threshold element (124) for determining a threshold value for a slicer element by using a histogram per column and/or row and/or area of said oversampled detected image.

9. Electronic device as claimed in claim 1, wherein said correction unit (120) further comprises:
a starting element (125) for determining a beginning of said reconstructed data page by detecting at least one data edge of said data page by using a non-zero value of a sum of at least one column and/or row as said beginning of said reconstructed data page.

10. Optical holographic device for reading out a data page recorded in a holographic recording medium (106), said device comprising:
an image detection unit (104, 105, 114) for detecting an oversampled detected image of said recorded data page, and
an electronic device (117) as defined in claim 1 for reconstructing a data page from said oversampled detected image.

11. Method for reconstructing a data page from an oversampled detected image of said data page, said method comprising the steps of:
extracting an oversampling factor from said oversampled detected image,
determining a correction information for a correction of said oversampled detected image with respect to said data page by using said extracted oversampling factor, and
correcting said oversampled detected image by using said determined correction information.

12. Method for use in an optical holographic device for reading out a data page recorded in a holographic recording medium (106) as defined in claim 10, comprising the steps of:
detecting an oversampled detected image of said recorded data page
reconstructing a data page from said oversampled detected image using a method as defined in claim 10.

13. Computer program comprising program code means for causing a computer to carry out the steps of the method as claimed in claim 11 when said computer program is carried out on a computer.
